(19) United States
(12) Patent Application Publication
(10) Pub. No.: US 2006/0250339 A1
(43) Pub. Date: Nov. 9, 2006

(54) Driving apparatus of liquid crystal display having organic electroluminescence backlight

(75) Inventor: Jeong Geun Kim, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/398,630

(22) Filed: Apr. 6, 2006

(30) Foreign Application Priority Data
May 4, 2005 (KR) 10-2005-0037464

(51) Int. Cl. G09G 3/36

(52) U.S. Cl. 345/87

(57) ABSTRACT

A liquid crystal display of a blink driving scheme includes a backlight comprised of an organic electroluminescence, a timing controller for producing a timing signal to control video data, a power supply for supplying a driving voltage having an active level, and a backlight controller for producing a backlight control signal having a regulated level of the driving voltage. The regulated level of the driving voltage is synchronized with the timing signal and is fed to the backlight to control a duty of the backlight in synchronization with the timing signal.

### FIELD OF THE INVENTION

The present invention relates to a liquid crystal display having an organic electroluminescence backlight, and more particularly, to a driving apparatus of a liquid crystal display having an organic electroluminescence backlight.

### BACKGROUND OF THE INVENTION

As is known in the art, differently from a cathode ray tub (CRT) being a representative emissive display, a liquid crystal display (LCD) is not a spontaneous-emissive display device that requires a light source to maintain uniform brightness in an entire picture.

Such LCDs are categorized into reflective, transmissive and transflective type LCDs, depending upon the form of illumination. The light source employed in a transmissive or a transflective LCD is referred to as a backlight. The backlight may be divided into a direct type and an edge type, pursuant to the location of the light source.

Various light sources including a small electric bulb, an inorganic thick-film EL display, a light emitting diode (LED), a cold cathode fluorescent lamp (CCFL) and an external electrode fluorescent lamp (EEFL) have been employed for the backlight. Among them, the CCFL is most commonly used as the backlight for a super twisted nematic (STN)-LCD or thin film transistor (TFT)-LCD since it is capable of producing high-luminance light required for full color representation.

However, the CCFL not only consumes a large amount of power, but also is thicker than the other ones, which results in thickening the LCD. Because the thickness in the backlight is one of significant factors for reducing the overall size of the LCD, the thick CCFL hinders to make the compact LCD.

In order to overcome the above problem, there has been proposed a backlight comprised of an organic electroluminescence (EL) device. The organic EL device has a spontaneous emissive property producing high-luminance light and has advantages of a simple structure, a lightweight and thinness. Moreover, it is ease to manufacture the organic EL device. Accordingly, the backlight comprised of the organic EL device, so called as an organic EL backlight, is capable of providing a high-luminance display and contributing to the compact LCD.

Such an organic EL backlight, for example, is disclosed in a co-pending, commonly owned application, U.S. Ser. No. ______ filed on Feb. 17, 2006, entitled “LIQUID CRYSTAL DISPLAY USING ORGANIC ELECTROLUMINESCENCE BACKLIGHT”, which is hereby incorporated by reference.

In general, as similar as a conventional organic EL device, the organic EL backlight used in the LCD is adapted to be driven by a power source supplying direct current (DC) voltage.

In case where the EL backlight is driven by the DC voltage, the EL backlight would not be turned-off at all owing to a constant level of the DC voltage. That is, the EL backlight continuously maintains a light emission state. As a result, the EL backlight is subject to thermal stress, which may cause a shortened life span of the EL backlight. Further, with the lapse of time, there occurs a voltage drop due to an increase of resistance, which leads to a deviation of luminance in the LCD.

In order to solve the above shortcoming, there has been a proposal to drive the EL backlight using a swing voltage from 0V to +5V or from −5V to +5V the AC voltage. In this case, the EL backlight will be repeatedly turned-off and turned-on pursuant to the fluctuation of the swing voltage. This measurement can compensate the shortened life span of the EL backlight.

On the other hand, in recent, most of the LCDs adopt a blink driving scheme in order to prevent a blur phenomenon originating from a slow response of the liquid crystal materials, unlike the CRT. In the blink driving scheme, pseudo data or black data is given instead of real data for each blank interval in order to secure hold time for the real data for a period of frame, field or line.

However, if the EL backlight is driven by the swing voltage in the LCD of the blink driving scheme, the blank intervals of the LCD cannot be matched with the light-out (blackout) intervals of the EL backlight. More specifically, the light-out timing of the EL backlight are not accorded to the blank timings of the LCD such that the intervals of the light-out intervals of the EL backlight occasionally overlaps with the blank intervals of the LCD. These may result in the presence of the blur phenomenon in the LCD of blink driving scheme.

Accordingly, there is a strong need to suggest a novel driving apparatus in the LCD of blink driving scheme with the EL backlight to overcome the blur phenomenon.

### SUMMARY OF THE INVENTION

An object of the present invention is, therefore, to provide a liquid crystal display of blink driving scheme having an organic electroluminescence (EL) backlight without having a blur phenomenon.

It is another object of the present invention to provide a driving apparatus for a liquid crystal display of blink driving scheme having an organic electroluminescence (EL) backlight.

In accordance with an aspect of the present invention, there is provided a liquid crystal display of a blink driving scheme, which comprises: an LCD panel for displaying video data; a backlight for providing white light to the LCD panel, wherein the backlight is comprised of an organic electroluminescence device; a timing controller for producing a timing signal to control the video data; a power supply for supplying a driving voltage having an active level; and a backlight controller for producing a backlight control signal having a regulated level of the driving voltage, the regulated level is synchronized with the timing signal and is fed to the backlight.

In accordance with another aspect of the present invention, there is provided a driving apparatus of a liquid crystal display (LCD) of a blink driving scheme having a backlight, wherein the backlight unit is comprised of an organic electroluminescence device, the driving apparatus comprises: a timing controller for producing a timing signal to control video data to be displayed on the LCD; a power supply for supplying a driving voltage having an active level; and a backlight controller for producing a backlight control signal having a regulated level of the driving voltage, wherein the regulated level is synchronized with the timing signal and is fed to the backlight to control the duty of the backlight.

### BRIEF DESCRIPTION OF THE DRAWINGS

The above and other objects and features of the present invention will become apparent from the following description of preferred embodiments given in conjunction with the accompanying drawings, in which:

FIG. 1 shows an overall configuration of the structure of an LCD having an organic EL backlight in according with the present invention;

FIG. 2 is a variety of waveforms of timing signals produced from the timing controller of FIG. 1; and

FIG. 3 is a sectional view of the organic EL backlight of FIG. 1.

### DETAILED DESCRIPTION OF THE PREFERRED EMBODIMENTS

Hereinafter, preferred embodiments of the present invention will be described in detail with reference to the accompanying drawings.

Referring to FIG. 1, there is shown a schematic view of a liquid crystal display (LCD) having an organic electroluminescence (EL) backlight according to a preferred embodiment of the present invention.

As shown in FIG. 1, the LCD 100 is generally comprises a display unit 10, a video processing unit 20, and a backlight controller 18. The display unit 10 includes a TFT-LCD panel 16, drivers 14 and 15, and a backlight 19; and the video processing unit 20 includes a VRAM (video random access memory) board 11, a timing controller 12 and a line memory 13.

The VRAM board 11, which may incorporate therein a graphic controller, produces digital video data RGB to be displayed and a synchronization signal SYNC. The timing controller 12 receives from the VRAM board 11 the synchronization (SYNC) signal and samples it to produce various timing signals necessary to drive the display unit 10. The timing signals, for example, includes a vertical synchronization (Vsync) signal, a horizontal synchronization (Hsync) signal, a data enable (DE) signal during which the video data is provided to the display unit 10, a clock (CLOCK) signal or the like. The video data RGB from the timing controller 12 is provided to a line memory 13 for temporally storing therein. The Hsync signal from the timing controller 12 is fed to a scan driver 14. The Vsync signal from the timing controller 12 is fed to the line memory 13 in which the video data RGB is then transmitted to a data driver 15 under the control of the Vsync signal.

The LCD 100 further comprises a power supply 17 which serves to supply electrical driving voltage having certain active level to the TFT-LCD 19, the backlight controller 18 and the like.

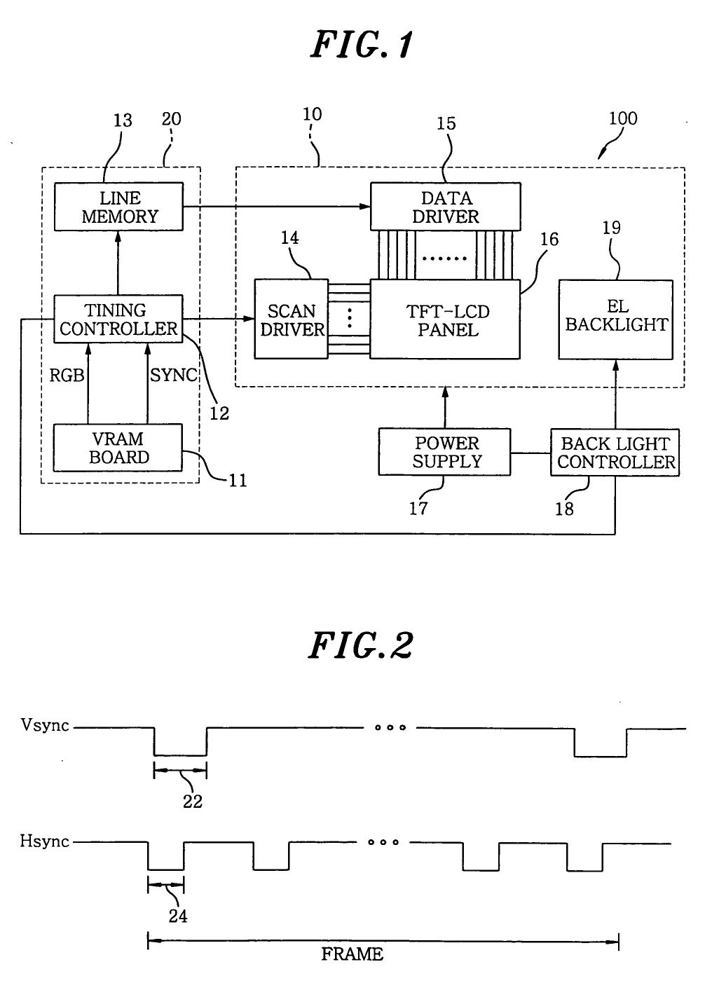

The backlight controller 18 receives the timing signals, e.g., the Vsync signal, the Hsync signal, or the DE signal. The backlight controller 18 regulates the level of the driving voltage supplied from the power supply 17 depending upon the timing signal, to thereby produce a backlight control (BC) signal having a regulated level that is synchronized with the timing signal. More specifically, referring to FIG. 2, there are shown a various timing signals from the timing controller 18.

As shown in FIG. 2, the Vsync signal has a vertical blank interval 22 for each period of a frame, and the Hsync signal has a plurality of horizontal blank intervals 24 for each period of a frame. Assuming that the backlight controller 18 is supplied with the Vsync signal as the timing signal, the backlight controller 18 detects the vertical blank interval 22 by way of sensing a falling edge and a rising edge of the Vsync signal. Then, the backlight controller 18 renders the level of the driving voltage inactive for a duration corresponding to the detected vertical blank interval 22, to thereby produce the BC signal with the regulated voltage level that is synchronized with the Vsync signal.

The BC signal is then fed to the EL backlight 19 for driving it and is used to control a duty of turn-on or turn-off of the EL backlight 19. The EL backlight 19 is controlled to maintain the turn-on status for the duration of an active level of the BC signal. However, the El backlight 19 is controlled to turn-off for the duration of an inactive level of the BC signal. Accordingly, the timing of the turn-off of the EL backlight 19 can be conformed to that of the blank interval of the timing signal. If the BC signal is made to conform to the Vsync signal, the duration of the turning-on intervals is relatively long, so that it is advantageous in terms of the power consumption and the luminance. In contrast, if the BC signal is made to conform to the Hsync signal having a frequency higher than that of the Vsync signal, the duty of the EL backlight 19 becomes short, so that it is disadvantageous in terms of the power consumption over the former but advantageous in terms of life time.

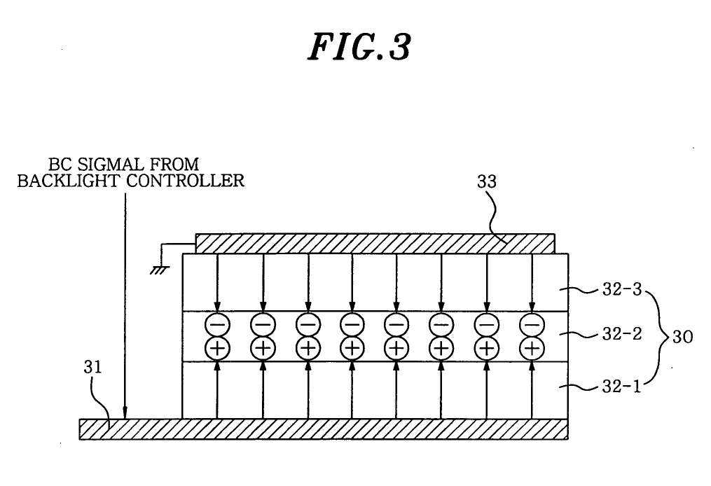

FIG. 3 is a detailed sectional view of the EL backlight of FIG. 1.

The EL backlight 19 includes an anode layer 31 made of a transparent conductive material such as indium tin oxide (ITO), polyaniline and silver (Ag), a cathode layer 33 made of a metal such as aluminum (Al) and an organic thin-film layer 32 formed between the anode layer 31 and the cathode layer 33.

The organic thin-film layer 32 has a hole injection/transport layer 32-1, an emission layer 32-2, and an electron injection/transport layer 32-3. The hole injection/transport layer 32-1 serves to transport holes injected from the anode layer 31 to the emission layer 32-2. The electron injection/transport layer 32-3 serves to transport electrons injected from the cathode layer 33 to the emission layer 32-2. The emission layer 32-2 serves to emit light through the combination of the transported electrons and holes. Such layers as the hole injection layer, the hole transport layer, the electron injection layer and the electron transport layer may be made of materials employed to fabricate a conventional organic EL device.

The cathode layer 33 is grounded and the anode layer 31 is connected to receive the BC signal from the backlight controller 18.

Upon being supplied with the BC signal, the EL backlight 19 is turned-on with an active level of the BC signal and is turned-off with an inactive level of the BC signal. That is to say, the duration of the inactive levels of the BC signal can be synchronized with the blank intervals of the timing signal, which causes to control the duty cycle of the EL backlight 19 in synchronization with the timing signal.

Accordingly, in accordance with the present invention, it is possible to prevent lifespan of the EL backlight from being shortened and to overcome a blur phenomenon.

While the invention has been shown and described with respect to the preferred embodiments, it will be understood by those skilled in the art that various changes and modifications may be made without departing from the spirit and scope of the invention as defined in the following claims.

What is claimed is:

1. A liquid crystal display (LCD) of a blink driving scheme, which comprises:
an LCD panel for displaying video data;
a backlight for providing white light to the LCD panel, wherein the backlight is comprised of an organic electroluminescence device;
a timing controller for producing a timing signal to control the video data;
a power supply for supplying a driving voltage having an active level; and
a backlight controller for producing a backlight control signal having a regulated level of the driving voltage to fed to the EL backlight for driving it, wherein the backlight control signal is synchronized with the timing signal.

2. The liquid crystal display of claim 1, wherein the timing signal includes a vertical synchronization signal, the vertical synchronization signal having a blank interval during which the backlight controller makes the level of the driving voltage inactive.

3. The liquid crystal display of claim 1, wherein the timing signal includes a horizontal synchronization signal, the horizontal synchronization signal having a blank interval during which the backlight controller makes the level of the driving voltage inactive.

4. The liquid crystal display of claim 2, wherein the backlight is turned-off for duration of the inactive level corresponding to the blank interval.

5. The liquid crystal display of claim 3, wherein the backlight is turned-off for duration of the inactive level corresponding to the blank interval.

6. A driving apparatus of a liquid crystal display (LCD) of a blink driving scheme having a backlight, wherein the backlight unit is comprised of an organic electroluminescence device, the driving apparatus comprises:
a timing controller for producing a timing signal to control video data to be displayed on the LCD;
a power supply for supplying a driving voltage having an active level; and
a backlight controller for producing a backlight control signal having a regulated level of the driving voltage, wherein the regulated level is synchronized with the timing signal and is fed to the backlight to control the duty of the backlight in synchronization with the timing signal.

7. The driving apparatus of claim 6, wherein the timing signal includes a vertical synchronization signal, the vertical synchronization signal having a blank interval during which the backlight controller makes the level of the driving voltage inactive.

8. The driving apparatus of claim 6, wherein the timing signal includes a horizontal synchronization signal, the horizontal synchronization signal having a blank interval during which the backlight controller makes the level of the driving voltage inactive.

9. The driving apparatus of claim 7, wherein the backlight is turned-off for duration of the inactive level corresponding to the blank interval.

10. The driving apparatus of claim 8, wherein the backlight is turned-off for duration of the inactive level corresponding to the blank interval.
